(19) United States
(12) Patent Application Publication
(10) Pub. No.: US 2013/0044500 A1
(43) Pub. Date: Feb. 21, 2013

(54) ELECTRONICS HOUSING FOR A LAMP, SEMICONDUCTOR LAMP AND METHOD FOR CASTING AN ELECTRONICS HOUSING FOR A LAMP

(71) Applicant: Fabian Reingruber, Muenchen (DE)

(72) Inventor: Fabian Reingruber, Muenchen (DE)

(73) Assignee: OSRAM AG, Muenchen (DE)

(21) Appl. No.: 13/583,969

(22) PCT Filed: May 2, 2011
(86) PCT No.: PCT/EP2011/056913

§ 371 Date: Sep. 11, 2012

(30) Foreign Application Priority Data
May 3, 2010 (DE) 102010028481.5

(51) Int. Cl. F21V 21/00; B29C 39/10

(52) U.S. Cl. 362/382; 264/259

(57) ABSTRACT

In various embodiments, an electronics housing for a lamp is provided, wherein an electronics printed circuit board is accommodated in an accommodating area surrounded by the electronics housing, and the electronics housing has an elongate channel, the channel connecting an outer side of the electronics housing to the accommodating area and extending substantially parallel to and offset with respect to the electronics printed circuit board.

The invention relates to an electronics housing, in particular a driver housing, for a lamp, wherein an electronics printed circuit board, in particular a driver printed circuit board, is accommodated in the accommodating area surrounded by the electronics housing. The invention also relates to a semiconductor lamp, having a heat sink with a cavity for accommodating an electronics housing and with at least one semiconductor light source, which is connected thermally to the heat sink, the driver printed circuit board being coupled to the at least one semiconductor light source in electrically functional fashion so as to provide the feed to said semiconductor light source. The invention also relates to a method for casting an electronics housing for a lamp.

EP 0 645 943 B1 describes an operating device for electric lamps, including a driver housing, an electric driver circuit, which is arranged in the interior of the driver housing, and a connection part, which has electrical connections for supplying voltage to the operating device and electrical connections for at least one electric lamp, a filling nozzle enabling casting compound to be introduced into the interior of the completely fitted operating device. One disadvantage here is that it is only possible to usefully fill the entire interior. However, complete casting of a driver housing does have disadvantages in respect of an increase in weight, component damage, expansion at a high temperature and high cost.

Therefore, the driver circuit is sometimes only partially connected to the driver housing. For this purpose, a paste-like, non-fluid material is introduced via a so-called dispenser needle, with the dispenser needle being directed to that point of the driver circuit which needs to be cast. In this case, the following problems result, inter alia: during insertion of the dispenser needle into the lamp, the driver electronics may be damaged. If the driver housing is subsequently closed, casting is no longer possible. If a small opening is left open for filling, the safety-relevant air gaps and leakage paths between the electronics and the touchable heat sink still need to be maintained.

The object of the present invention consists in at least diminishing at least one of the disadvantages of the prior art and in particular providing a possibility for flexible and inexpensive casting of components of an electronic circuit of a lamp in a manner which is operationally safe and protects against damage.

This object is achieved in accordance with the features of the independent claims. Preferred embodiments can be gleaned in particular from the dependent claims.

The object is achieved by an electronics housing for a lamp, wherein an electronics printed circuit board (or driver printed circuit board) is accommodated in an accommodating area surrounded by the electronics housing, and the electronics housing has an elongate channel, the channel connecting an outer side of the electronics housing to the accommodating area and extending substantially parallel to and offset with respect to the electronics printed circuit board.

By means of the elongate channel, a filling tool, for example a needle, which fits through the channel, can be inserted from the outside into the accommodating area in a direction predetermined by the longitudinal alignment of the channel, to be precise substantially parallel to the electronics printed circuit board. As a result, the tool can in principle be positioned as desired along the electronics printed circuit board and consequently process various regions of the electronics printed circuit board or the accommodating area in a targeted manner. Thus, the tool can be provided with at least one casting opening, which can be positioned in a targeted manner in order to cast at least one subarea of the accommodating area with a casting material emerging therefrom. Thus, a cast volume can be kept particularly small, if required, which saves on costs and weight. In addition, the use of different electronics printed circuit boards without any or without any substantial matching of the electronics housing or the tool is possible, which saves further on costs. The length of the channel also makes it possible to maintain air gaps and leakage paths. The insertion of the tool parallel to the electronics printed circuit board furthermore prevents the tool from being able to touch the electronics printed circuit board and thus damage it.

The electronics housing can be inserted into a heat sink. The electronics housing can also have at least one cable bushing for passing through at least one electrical line (cable, wire etc.).

One configuration consists in that the electronics printed circuit board is populated on its first side with at least one component using SMD technology (SMD component) and is populated on its second side with at least one component using wiring technology (wired component), the channel being opposite the first side. In other words, the channel is arranged in such a way that a casting compound emerging out of the tool located in the channel first hits the first side of the electronics printed circuit board.

In particular, the casting can only be performed using SMD components which (in contrast to the components with which contact is normally made by means of wires) are insensitive to the casting process, with the result that damage to the populated electronics printed circuit board can be avoided. A particular development consists in that the electronics printed circuit board is populated on its first side only with at least one component using SMD technology and is populated on its second side only with at least one component using wiring technology.

In other words, the electronics printed circuit board is populated on its first side exclusively with one or more components using SMD technology and is populated on its second side exclusively with one or more components using wiring technology.

Specifically, partial casting with a paste-like material only on the SMD components has the advantage over complete casting that the casting material can expand and contract more effectively with the temperature. Since the casting only relates to the SMD side, the sensitive wired components cannot be damaged.

A further configuration consists in that the electronics printed circuit board splits the accommodating area substantially into two accommodating regions, of which a first accommodating region is delimited by the electronics housing and the first side of the electronics printed circuit board and a second accommodating region is delimited by the electronics housing and the second side of the electronics printed circuit board. Then, the tool is inserted only into one of the accommodating regions, preferably the first accommodating region, which makes it possible to decouple the casting of the two accommodating areas.

One development consists in that the electronics printed circuit board splits the accommodating area substantially completely into two accommodating regions, i.e. is in the form of a partition. As a result, it is possible to minimize the passage of casting compound from one of the accommodating regions over to the other of the accommodating regions. In order to allow the compressed air to escape effectively during casting of one of the accommodating regions, at least one through-opening can be provided in the electronics printed circuit board, through which through-opening the compressed air can escape into the other accommodating region.

The electronics printed circuit board can have one or more cooling faces, for example cooling ribs, for increased heat dissipation.

Another development consists in that the electronics housing is a driver housing and the electronics printed circuit board is a driver printed circuit board.

A further development consists in that the channel extends into the accommodating area. Thus, the electronics housing can be used without any matching of a component, for example heat sink, surrounding said electronics housing.

Another development consists in that the channel extends outwards. Thus, the channel which protrudes for example in tubular fashion from the housing can be inserted into the heat sink, for example, and can thus be used to fix the electronics housing and possibly also as a cable bushing.

Yet a further configuration consists in that the electronics housing has a projection which protrudes into the accommodating area and is located spaced apart from the channel in a direction of extent of the channel. By virtue of the projection, a penetration depth of the tool into the accommodating area can be limited. Thus, a position of the tool in the accommodating area can be adjusted with a high degree of accuracy, and in addition the projection can be used for constricting the accommodating area, with the result that filling of a subarea positioned between the accommodating area and the channel can be performed substantially separately and largely without the introduction of casting material into the rest of the accommodating area.

An additional configuration consists in that the electronics housing is cast at least partially with a thermally conductive casting material, the casting material making contact between at least one component used for the population using SMD technology and the electronics housing. As a result, the component used for the population using SMD technology can be coupled thermally to the electronics housing and thereby also to a heat sink. Another configuration consists in that the casting material makes contact between at least one component used for the population using wiring technology and the electronics housing. This may be the case in particular when the accommodating area is completely cast.

An additional configuration consists in that the electronics housing is formed in two parts with a first housing part and a second housing part, the first housing part and the second housing part being connected to one another, at least sectionally, via a labyrinth-like (in particular in profile) mechanical contact. It is thus possible to safely prevent the casting material from emerging out of the electronics housing in an undesired manner. The labyrinth-like mechanical contact can be realized, for example, by virtue of the fact that a projection on one housing part is inserted into a matching cutout in the other housing part.

The object is also achieved by a semiconductor lamp, having a heat sink with a cavity for accommodating an electronics housing, as described above, and at least one semiconductor light source, which is connected thermally to the heat sink, wherein the electronics printed circuit board is coupled to the at least one semiconductor light source in electrically functional fashion in order to provide the feed to said semiconductor light source.

Preferably, the at least one semiconductor light source includes at least one light-emitting diode. When there is more than one light-emitting diode, said light-emitting diodes can illuminate in the same color or in different colors. A color can be monochrome (for example red, green, blue etc.) or multichrome (for example white). The light emitted by the at least one light-emitting diode can also be an infrared light (IR-LED) or an ultraviolet light (UV-LED). A plurality of light-emitting diodes can produce a mixed light; for example a white mixed light. The at least one light-emitting diode can contain at least one wavelength conversion phosphor (conversion LED). The at least one light-emitting diode can be present in the form of at least one individually housed light-emitting diode or in the form of at least one LED chip. A plurality of LED chips can be fitted on a common substrate (“submount”). The at least one light-emitting diode can be equipped with at least one dedicated and/or common optical element for beam guidance, for example at least one Fresnel lens, collimator etc. Instead of or in addition to inorganic light-emitting diodes, for example on the basis of InGaN or AlInGaP, organic LEDs (OLEDs, for example polymer OLEDs) can generally also be used. Alternatively, the at least one semiconductor light source can have, for example, at least one diode laser.

The semiconductor lamp can be in particular a retrofit lamp, in particular an incandescent lamp retrofit lamp.

The object is also achieved by a method for casting an electronics housing for a lamp, wherein
an electronics printed circuit board is accommodated in an accommodating area surrounded by the electronics housing,
a filling tool, in particular a needle (dispenser needle or the like), is inserted into the accommodating region, substantially parallel to a plane of the electronics printed circuit board, through an elongate channel in the electronics housing,
a casting material is introduced into the accommodating area through at least one casting opening of the filling tool,
and the casting material connects at least one component of the electronics printed circuit board to the electronics housing.

This results in the same advantages as already mentioned for the electronics housing.

One configuration consists in that the filling tool is inserted into a region of the electronics housing, which region is delimited partially by a first side of the electronics printed circuit board, which is populated with at least one component using SMD technology. It is thus possible for in particular the SMD components to be cast with the casting compound in a targeted manner.

A further configuration consists in that the filling tool has a stop, which limits a penetration depth of the filling tool into the accommodating area. As a result, the filling tool can be positioned in the accommodating area with a high degree of accuracy, in particular directly next to a component to be cast.

Yet a further configuration consists in that the filling tool, during its insertion into the accommodating area, rests on a stop of the electronics housing, which stop projects into the accommodating area. It is thus possible to set a position of the tool in the accommodating area with a high degree of accuracy and also it is possible for the projection to serve to constrict the accommodating area, with the result that filling of a subarea positioned between the accommodating area and the channel can be performed substantially separately and largely without casting material being introduced into the rest of the accommodating area.

An additional configuration consists in that the filling tool is inserted so far into the accommodating area that the at least one casting opening of the filling tool is substantially opposite the at least one component to be cast. It is thus possible for the casting material to be applied, through the at least one casting opening, substantially directly onto the desired component, which enables particularly economical consumption of casting material.

An additional configuration consists in that the filling tool has a plurality of outlet or casting openings, through which a plurality of components are cast simultaneously, and wherein a size of the casting openings is matched to an area to be cast of the respectively associated components. For example, casting from a comparatively large casting opening can be provided for a comparatively large-area component.

The invention will be described schematically in more detail with reference to exemplary embodiments in the following figures. In said figures, identical or functionally identical elements can be provided with the same reference symbols for reasons of clarity.

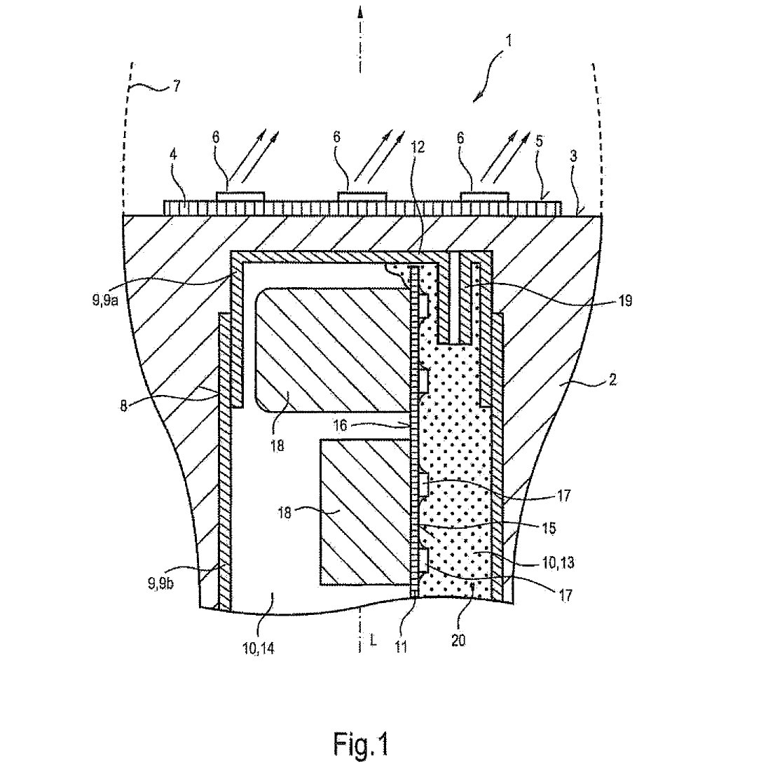

FIG. 1 shows a sectional illustration in a side view of a detail of a semiconductor lamp with a detail of a partially filled electronics housing;

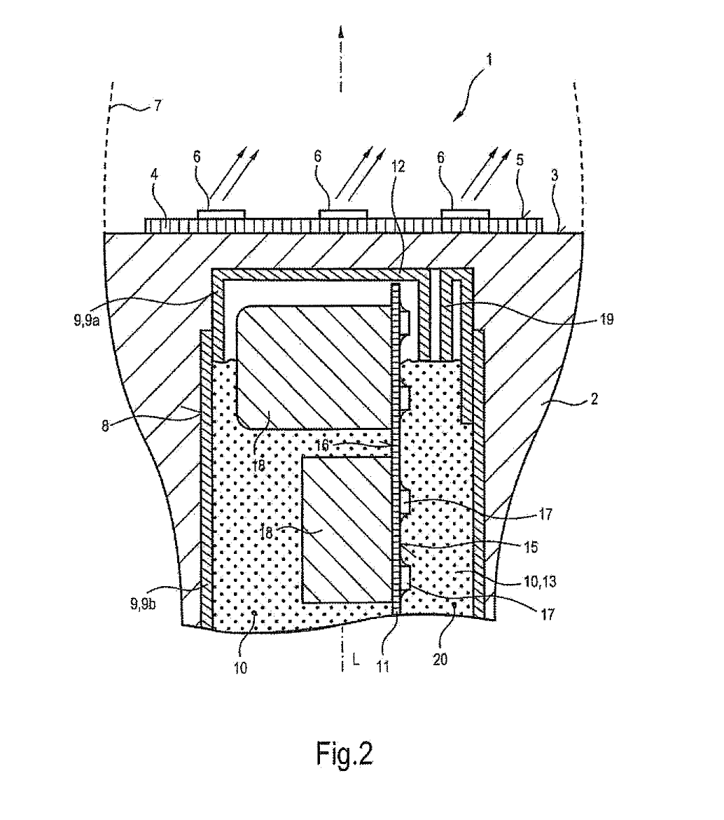

FIG. 2 shows the semiconductor lamp with a substantially completely filled electronics housing;

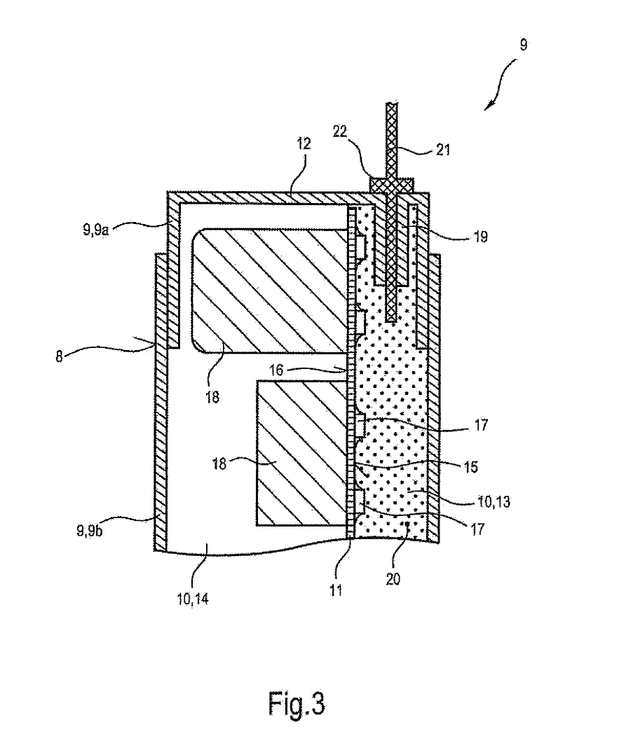

FIG. 3 shows a sectional illustration in a side view of a detail of the electronics housing shown in FIG. 1 and FIG. 2 with a filling tool inserted;

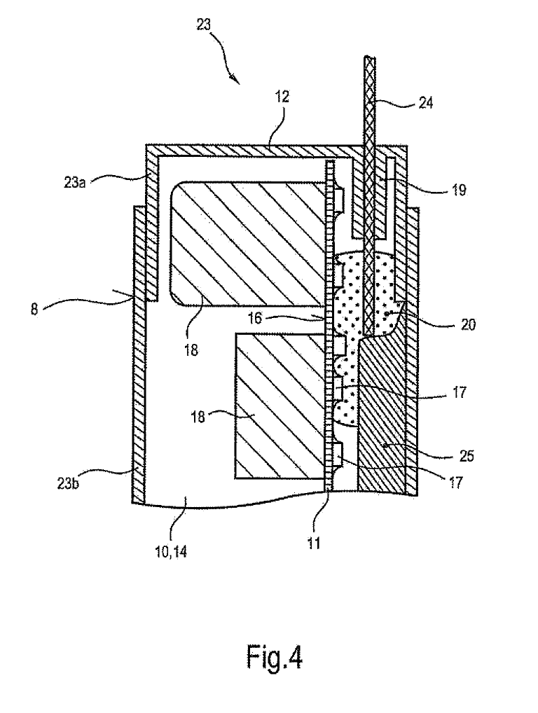

FIG. 4 shows a sectional illustration in a side view of a detail of a further housing, which is suitable for use in a semiconductor lamp as shown in FIG. 1 and FIG. 2, with a filling tool inserted; and

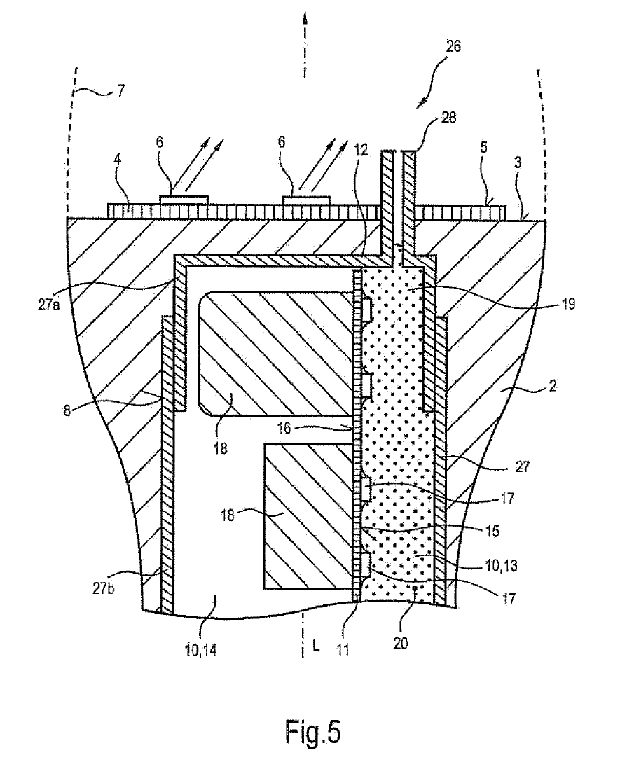

FIG. 5 shows a sectional illustration in a side view of a detail of a semiconductor lamp with a detail of a partially filled electronics housing in accordance with a further exemplary embodiment.

FIG. 1 shows an LED lamp 1, which represents part of an incandescent lamp retrofit lamp, for example. The LED lamp has a substantially rotationally symmetrical outer contour with respect to a longitudinal axis L. The LED lamp 1 has a heat sink 2, for example with aluminum, which can have cooling ribs on its outer circumferential surface. An LED printed circuit board 4 rests flat on a front side 3 of the heat sink 2. A front side 5 of the LED printed circuit board 4 is populated with a plurality of light-emitting diodes (LEDs) 6, which emit substantially into a front half-space of the LED lamp 1. The LED printed circuit board 4 rests flat with its rear side on the heat sink, with the result that the waste heat produced by the LEDs 6 during operation can be transmitted effectively to the heat sink 2. The LEDs 6 have a bulb 7 arching over them, which bulb can in particular act as a diffuser. The bulb 7 is likewise fastened to the heat sink 2.

In addition, the heat sink 2 has a cavity 8 for the substantially conformal accommodation of an electronics housing in the form of a driver housing 9. The driver housing 9 is formed in two parts from an upper housing part 9a and a lower housing part 9b. The driver housing 9 can be inserted into the cavity 8 from below. At the rear, the cavity 8 with the driver housing 9 can be closed by a base (not shown). The driver housing 9 surrounds an accommodating area 10 for electronics or an electronics printed circuit board in the form of a driver printed circuit board 11.

The driver printed circuit board 11 is parallel to the longitudinal axis or perpendicular in the driver housing 9 and may have been inserted, for example, by means of suitable guide rails running perpendicularly (not illustrated). In addition, the driver printed circuit board 11 may have a curvature in order to conform better to the adjacent flat region of the driver housing 9. The driver printed circuit board 11 abuts an upper wall 12 of the driver housing 9 and can also bear against a lower wall positioned opposite (not illustrated). The driver printed circuit board 11 therefore splits the accommodating area 10 into a first accommodating region 13 and a second accommodating region 14. The first accommodating region 13 is delimited by a first side 15 of the driver printed circuit board 11 and the driver housing 9, and the second accommodating region 13 is delimited by a second side 16 of the driver printed circuit board 11 and the remaining part of the driver housing 9. The driver printed circuit board 11 is populated on both sides, to be precise with components 17 using surface mount technology (SMDs) on its first side 15 and at least partially with components 18 using wiring technology on its second side.

The populated driver printed circuit board 11 can be supplied with current via the base, which can be inserted into a matching current-conducting lampholder, and for its part feeds the LEDs 6. A cable bushing, for example a central cable bushing, for passing through at least one electrical line (cable, wire etc.) between the driver printed circuit board and the LED printed circuit board 4 is not illustrated.

The upper housing part 9a (facing the LED printed circuit board 4) has an elongate, tubular channel 19, which connects an outer side of the driver housing 9 to the accommodating area 10 and extends parallel to and offset with respect to the driver printed circuit board 11 and the longitudinal axis L. The channel 19 extends from the upper wall 12 perpendicularly into the first subregion 13 of the accommodating area 10. The length of the channel 19 is matched in such a way that the required safety distances (air gaps and leakage paths) between the driver printed circuit board 11 and the heat sink 2 are maintained.

The first subregion 13 can be cast through the channel 19 with a paste-like or semi-fluid casting material (casting compound) 20. This can be performed, for example, by inserting a casting tool, in particular in the form of a filling needle. The casting tool, owing to the linearly elongated form of the channel 19, cannot touch the driver printed circuit board, with the result that the driver printed circuit board 11 cannot be damaged. In addition, the filling tool can be positioned at a desired height (along the longitudinal axis L), with the result that a targeted filling position can be achieved. Since the driver printed circuit board 11 in this case acts as a partition, the first subregion 13 can be filled without the second subregion 14 being filled. Owing to the pressure of the casting material, at best some casting material 20 can possibly gush through the gap between one edge of the driver printed circuit board 11 and the driver housing 9. In particular, the first subregion does not need to be completely filled, in particular up to approximately 80%, with the result that particularly little casting material 20 passes into the second subregion 14. The gap can also be used to ventilate the first subregion 13 in order to allow air which has been compressed by the casting material 20 to pass through.

Owing to this arrangement, the SMD components 17 can be cast with the casting material in a simple manner, while the components 18 which are less suitable for casting with the paste-like material and using wiring technology are not cast. The casting material 20 produces a contact between at least one SMD component 17 and the driver housing 9 and forms a thermal link. Since the casting material 20 in particular has good thermal conductivity, effective heat dissipation of the SMD components 17 can thus be achieved to the surrounding environment via the casting material 20, the driver housing 9 and the heat sink 2. The partial filling is also less expensive and easier than complete filling.

The driver housing 9 can be filled in the closed state, in which the upper housing part 9a is connected to the lower housing part 9b, and then inserted into the cavity 8. The upper housing part 9a and the lower housing part 9b forms a labyrinth-like mechanical contact to a surrounding contact area, for example by virtue of one of the housing parts 9a, 9b having a peripheral, perpendicular projection (not illustrated) and the other housing part 9b, 9a having a fitting annular groove (not illustrated), which are in engagement with one another. Alternatively, the housing parts 9a, 9b can be plugged one inside the other in fitting fashion over a comparatively great length, as is shown.

FIG. 2 shows the LED lamp 1, with now the second subregion 14 also being filled with the casting material 20. In total, the accommodating area 10 is filled to approximately 80%. Complete filling can be simplified, for example, by a large gap between the driver printed circuit board 11 and a lower wall of the driver housing 9.

Ventilation of the driver housing 9 towards the outside can be performed through the cable bushing (not illustrated), for example.

FIG. 3 shows a sectional illustration in a side view of a detail of the driver housing 9 with a filling tool in the form of a filling or dispenser needle 21 inserted. The dispenser needle 21 can be inserted into the channel 19 in a straight line with little play, with the result that it cannot bend substantially with respect to the longitudinal direction of the channel 19 and is guided safely past the driver printed circuit board 11. In other words, the diameter of the channel 19 is matched to the diameter of the dispenser needle 21, with the result that damage to the components 17 during introduction and removal of the dispenser needle 21 is not possible.

A casting opening of the dispenser needle 21 can be located at the tip thereof or on a lateral wall, for example. Paste-like or semi-fluid casting material is pushed out through the casting opening. By means of adjusting a penetration depth of the dispenser needle 21 into the accommodating area 10, the location or the height of the outlet of the casting material can be fixed. As a result, it is possible in particular to achieve a situation in which a component 17 which is located approximately at the height of the casting opening is cast effectively with a high degree of safety. In other words, the position of the outlet point of the casting material can be varied via the dispenser needle 21. The dispenser needle 21 under some circumstances extends the channel 19 temporarily and is removed again after casting.

The dispenser needle 21 can be matched to the specifically designed driver printed circuit board 11, for example by virtue of the provision of a stop 22, with the result that the dispenser needle 21 is positioned in front of the component 17 preferred for casting.

FIG. 4 shows a sectional illustration in a side view of a detail of a further housing 23 suitable for use in a semiconductor lamp 1 with a filling tool in the form of a dispenser needle 24 inserted. The housing 23 has a similar design to the housing 9, apart from the fact that a projection 25 extending laterally into the accommodating area 10 is now provided on the lower housing part 23b, said projection protruding into the path of the dispenser needle 24. As a result, the projection 25 acts as a stop for the dispenser needle 24, said stop limiting the penetration depth of the dispenser needle 24, as a result of which the stop 22 is no longer needed.

In addition, the projection 25 performs the function of a barrier. This barrier prevents the casting material 20, in the case of perpendicular filling, from first falling into the lower part of the housing 23 and filling the housing 23 or the accommodating area 10 thereof slowly from there. If the paste-like casting material 20 is caught on the projection 25, a small bubble of casting material 20 is formed around the casting opening. This bubble increases in size slowly and, as it increases in size, the pressure around the casting opening also increases. This pressure guarantees that closely positioned SMD components 17 are completely cast. In addition, a particularly small cast volume can be achieved.

FIG. 5 shows a sectional illustration in a side view of a detail of an LED lamp 26 similar to the LED lamp 1, apart from the fact that the driver housing 27 now has a channel 28 for inserting a filling tool, in particular a dispenser needle, which channel extends from the housing 27 outwards, to be more precise in this case forwards through the heat sink 2 and the LED printed circuit board 4. This has the advantage that the driver housing 27 can still be filled when the LED lamp 26 is fitted or partially fitted. The channel 28 can also act as a cable bushing.

It goes without saying that the present invention is not restricted to the exemplary embodiments shown. In particular, the orientation of the housing during casting can differ from the illustration in the figures, for example in such a way that the channel is above the electronics printed circuit board.

### LIST OF REFERENCE SYMBOLS

1 LED lamp/semiconductor lamp
2 Heat sink
3 Front side of heat sink
4 LED printed circuit board
5 Front side of LED printed circuit board
6 LED
7 Bulb
8 Cavity
9 Driver housing/electronics housing
9a Upper housing part
9b Lower housing part
10 Accommodating area
11 Driver printed circuit board
12 Upper wall of driver housing
13 First accommodating region
14 Second accommodating region
15 First side of driver printed circuit board
16 Second side of driver printed circuit board
17 SMD component
18 Component using wiring technology
19 Channel
20 Casting material
21 Dispenser needle
22 Stop
23 Housing
23a Upper housing part
23b Lower housing part
24 Dispenser needle
25 Projection
26 LED lamp
27 Driver housing
28 Channel
L Longitudinal axis

1. An electronics housing for a lamp, comprising:
an electronics printed circuit board, and
an accommodating area within which the printed circuit board is accommodated, the accommodating area being surrounded by the electronics housing
wherein the electronics housing has an elongate channel, the channel connecting an outer side of the electronics housing to the accommodating area and extending substantially parallel to and offset with respect to the electronics printed circuit board.

2. The electronics housing as claimed in claim 1, wherein the electronics printed circuit board is populated on a first side with at least one component using surface mounted device technology and is populated on a second side with at least one component using wiring technology, the channel being opposite the first side.

3. The electronics housing as claimed in claim 2, wherein the electronics printed circuit board splits the accommodating area substantially into two accommodating regions, of which a first accommodating region is delimited by the electronics housing and the first side of the electronics printed circuit board and a second accommodating region is delimited by the electronics housing and the second side of the electronics printed circuit board.

4. The electronics housing as claimed in claim 1,
wherein the channel extends into the accommodating area.

5. The electronics housing as claimed in claim 1,
wherein the channel extends outwards.

6. The electronics housing as claimed in claim 1,
wherein the electronics housing has a projection which protrudes into the accommodating area and is located spaced apart from the channel in a direction of extent of the channel.

7. The electronics housing as claimed in claim 2,
wherein the electronics housing is cast at least partially with a thermally conductive casting material, the casting material making contact between at least one component of the population using surface mounted device technology and the electronics housing.

8. The electronics housing as claimed in claim 2,
wherein the casting material makes contact between at least one component of the population using wiring technology and the electronics housing.

9. The electronics housing as claimed in claim 1,
wherein the electronics housing is formed in two parts with a first housing part and a second housing part, the first housing part and the second housing part being connected to one another, at least sectionally, via a labyrinth-like mechanical contact.

10. A method for casting an electronics housing for a lamp, the method comprising:
accommodating an electronics printed circuit board in an accommodating area surrounded by the electronics housing;
inserting a filling tool into the accommodating region,
substantially parallel to a plane of the electronics printed circuit board, through an elongate channel in the electronics housing;
introducing a casting material into the accommodating area through at least one casting opening of the filling tool;
wherein the casting material connects a component of the electronics printed circuit board to the electronics housing.

11. The method as claimed in claim 10,
wherein the filling tool is inserted into a region of the electronics housing, which region is delimited partially by a first side of the electronics printed circuit board, which is populated with at least one component using surface mounted device technology.

12. The method as claimed in claim 10,
wherein the filling tool has a stop, which limits a penetration depth of the filling tool into the accommodating area.

13. The method as claimed in claim 10,
wherein the filling tool, during its insertion into the accommodating area, rests on a stop of the electronics housing, which stop projects into the accommodating area.

14. The method as claimed in claim 10,
wherein the filling tool is inserted so far into the accommodating area that the at least one casting opening of the filling tool is substantially opposite the at least one component to be cast.

15. The method as claimed in claim 10,
wherein the filling tool has a plurality of casting openings, through which a plurality of components are cast simultaneously, and wherein a size of the casting openings is matched to an area to be cast of the respectively associated components.

16. The electronics housing as claimed in claim 1,
wherein the electronics housing is a driver housing.

17. The electronics housing as claimed in claim 1,
wherein the electronics printed circuit board is a driver printed circuit board.

18. The method as claimed in claim 10,
wherein inserting the filling tool into the accommodating region comprises inserting a casting needle into the accommodating region.
